(19) United States
(12) Patent Application Publication
(10) Pub. No.: US 2023/0251352 A1
(43) Pub. Date: Aug. 10, 2023

(54) PROTECTIVE ASSEMBLY FOR A LASER MEASUREMENT SYSTEM

(71) Applicant: LM Wind Power Blades (Canada) Inc., Gaspe (CA)

(72) Inventor: Marc-Andre Begin, Gaspe (CA)

(21) Appl. No.: 17/668,462

(22) Filed: Feb. 10, 2022

(51) Int. Cl. G01S 7/481; G01S 17/02; G01S 17/89

(52) U.S. Cl. CPC G01S 7/4813; G01S 17/02; G01S 17/89

(57) ABSTRACT

A protective assembly for a laser measurement system configured to measure geometry of a component includes a housing configured to be embedded in a support surface on which the component is supported. The housing, in turn, includes a bottom wall and a side wall coupled to the bottom wall such that the housing defines a chamber therein. Furthermore, the protective assembly includes a target positioned within the chamber, with the target configured to receive a reflector that reflects a laser beam emitted by an emitter of the laser measurement system. Additionally, the protective assembly includes a cover configured to be removably coupled to the housing such that, when the cover is coupled to the housing, access to the chamber is occluded to protect the target from an environment outside of the chamber.

### FIELD

The present disclosure generally relates to laser measurement systems, such as a laser measurement system suitable for measuring the geometry of a wind turbine blade. More particularly, the present disclosure relates to a protective assembly for a laser measurement system.

### BACKGROUND

The geometry of a wind turbine blade is of critical importance to its aerodynamic performance. In this respect, it is generally desirable to validate the geometry of a wind turbine blade before installation on a wind turbine. For example, a laser measurement system may be used to measure various geometric characteristics of a wind turbine blade.

In general, laser measurement systems rely on targets or drift nests positioned around the component to ensure accurate measurements. Current targets designed for permanent installation (e.g., in a metrology lab) are not suitable for the environment in which wind turbine blades are produced. For example, dust, chemicals, forklifts, and/or the like present within a blade manufacturing facility can easily damage the targets.

As such, when using a laser measurement system to validate wind turbine blade geometry, targets are temporarily attached to the blade via adhesive. This provides some protection from the blade production environment. However, it is time consuming and expensive to attach and then subsequently remove targets from a wind turbine blade.

### BRIEF DESCRIPTION

Aspects and advantages of the technology will be set forth in part in the following description, or may be obvious from the description, or may be learned through practice of the technology.

In one aspect, the present subject matter is directed to a protective assembly for a laser measurement system configured to measure geometry of a component. The protective assembly includes a housing configured to be embedded in a support surface on which the component is supported. The housing, in turn, includes a bottom wall and a side wall coupled to the bottom wall such that the housing defines a chamber therein. Furthermore, the protective assembly includes a target positioned within the chamber, with the target configured to receive a reflector that reflects a laser beam emitted by an emitter of the laser measurement system. Additionally, the protective assembly includes a cover configured to be removably coupled to the housing such that, when the cover is coupled to the housing, access to the chamber is occluded to protect the target from an environment outside of the chamber.

In another aspect, the present subject matter is directed to a system for measuring wind turbine blade geometry. The system includes a laser measurement system having an emitter configured to emit a laser beam for use in measuring geometry of a wind turbine blade and a target configured to receive a reflector that reflects the laser beam emitted by the emitter. Moreover, the system includes a support surface on which the laser measurement system and the wind turbine blade are supported. In addition, the system includes a protective assembly having a housing embedded in the support surface, with the housing including a bottom wall and a side wall coupled to the bottom wall such that the housing defines a chamber therein. The target is positioned within the chamber. In addition, the protective assembly includes a cover configured to be removably coupled to the housing such that, when the cover is coupled to the housing, access to the chamber is occluded to protect the target from an environment outside of the chamber.

In a further aspect the present subject matter is directed to a method for measuring wind turbine blade geometry. The method includes removing a cover of a protective assembly embedded in a support surface from a housing of the protective assembly to provide access to a target positioned within a chamber of the protective assembly. Furthermore, the method includes controlling an operation of an emitter of a laser measurement system such that a laser beam is directed at the target at a first time. Additionally, the method includes controlling the operation of the laser measurement system to measure a geometry of a wind turbine blade supported on the support surface. Moreover, the method includes controlling the operation of the emitter such that the laser beam is directed at the target at a second time after measuring the geometry. In addition, the method includes coupling the cover to the housing to protect the target from an environment outside of the chamber.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 is a diagrammatic view of one embodiment of a system for measuring component geometry;

FIG. 2 is a perspective view of one embodiment of a protective assembly for a laser measurement system configured to measure geometry of a component;

FIG. 3 is another perspective view of the embodiment of the protective assembly shown in FIG. 2;

FIG. 4 is a perspective view of one embodiment of a housing of the protective assembly;

FIG. 5 is a cross-sectional view of another embodiment of a housing of the protective assembly;

FIG. 6 is a perspective view of one embodiment of a cover of the protective assembly;

FIG. 7 is a cross-sectional view of the embodiment of the protective assembly shown in FIG. 2;

FIG. 8 is a perspective view of one embodiment of a tool for use in removing the cover from the housing;

FIG. 9 is a flow diagram of a method for measuring wind turbine blade geometry;

FIG. 10 is a perspective view of the tool being used to remove the cover from the housing; and

FIG. 11 is a perspective view of the cover being placed within a chamber of the tool.

Repeat use of reference characters in the present specification and drawings is intended to represent the same or analogous features or elements of the present technology.

### DETAILED DESCRIPTION

Reference will now be made in detail to present embodiments of the technology, one or more examples of which are illustrated in the accompanying drawings. The detailed description uses numerical and letter designations to refer to features in the drawings. Like or similar designations in the drawings and description have been used to refer to like or similar parts of the technology. As used herein, the terms “first”, “second”, and “third” may be used interchangeably to distinguish one component from another and are not intended to signify location or importance of the individual components.

Each example is provided by way of explanation of the technology, not limitation of the technology. In fact, it will be apparent to those skilled in the art that modifications and variations can be made in the present technology without departing from the scope or spirit thereof. For instance, features illustrated or described as part of one embodiment may be used on another embodiment to yield a still further embodiment. Thus, it is intended that the present technology covers such modifications and variations as come within the scope of the appended claims and their equivalents.

In general, the present subject matter is directed to a protective assembly for a laser measurement system configured to measure geometry of a component (e.g., a wind turbine blade). Specifically, in several embodiments, the protective assembly includes a housing configured to be embedded in a support surface on which the component is supported during measurement. For example, the housing may be embedded within the floor of the building or facility in which the wind turbine blade is being produced. The housing, in turn, includes a bottom wall and a side wall coupled to the bottom wall such that the housing defines a chamber therein. Furthermore, a target or drift nest is positioned within the chamber. The target, in turn, is used to ensure the accuracy of the laser measurement system. Additionally, the protective assembly includes a cover configured to be removably coupled to the housing.

The protective assembly improves the operation of the target and the associated laser measurement system by protecting the target from the environment (e.g., of the blade production facility). Specifically, when the cover is removed, access to the target is provided. As such, a reflector received by the target (e.g., magnetically coupled to the target) can reflect a laser beam(s) emitted by an emitter of the laser measurement system (e.g., to ensure the laser measurement system has not moved during measurement of the component). However, when the cover is coupled to the housing, access to the chamber is occluded to protect the target. This, in turn, protects the target from the environment outside of the chamber (e.g., the environment of the blade production facility). In this respect, the protective assembly shields the target from dust, chemicals, forklifts, and/or the like when the target is not in use. Thus, protective assembly allows for permanent installation of the target in harsh environment, such as those in which wind turbine blades are produced. Accordingly, the disclosed protective assembly eliminates the need to adhesively couple targets to a wind turbine blade when validating the geometry of the blade, thereby reducing the time and cost of such validation.

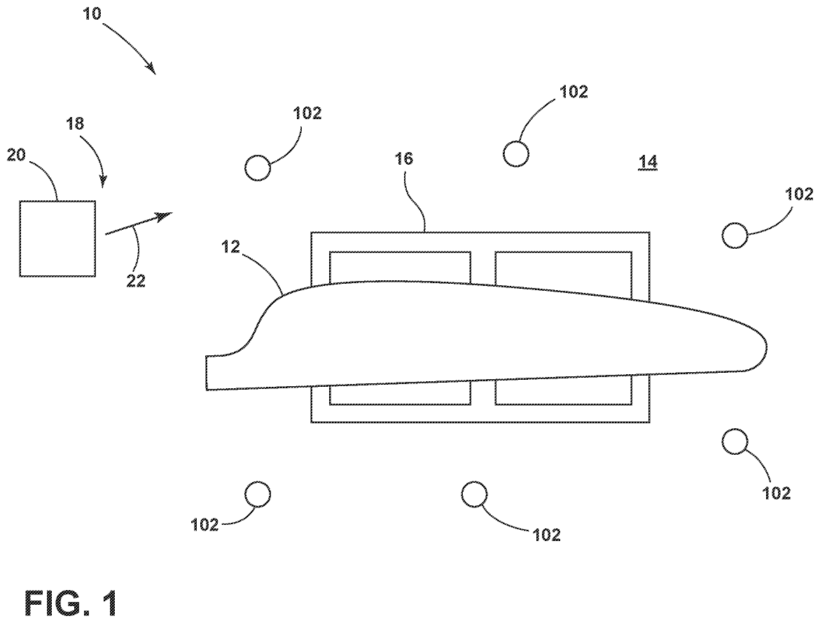

Referring now to the drawings, FIG. 1 is a diagrammatic view of one embodiment of a system 10 for measuring component geometry. In the illustrated embodiment, the system 10 is configured to measure the geometry of a wind turbine rotor blade 12. For example, as shown, the wind turbine blade 12 is supported relative to a support surface 14 (e.g., a building or shop floor) by a jig 16. However, in alternative embodiments, the system 10 may be configured to measure the geometry of any other suitable type of component.

As used herein, the term “geometry” refers to any parameter associated with the shape and/or size of the component. Thus, the geometry of the component may include lengths, widths, heights, positions, curvatures, and/or the like. For example, in the context of the wind turbine blade 12, the measured geometry may include a curvature of the blade 12.

Furthermore, the system 10 includes a laser measurement system 18. In general, the laser measurement system 18 is configured to use a laser(s) or other emitted beam(s) to measure or otherwise determine one or more geometric parameters of the wind turbine blade 12 or other component being measured. In this respect, the laser measurement system 18 may include an emitter 20 (e.g., a LiDAR scanner) that emits one or more laser beams (e.g., as indicated by arrow 22) at the surface of the wind turbine blade 12. At least a portion of the emitted laser beam(s) are reflected off of the surface of the wind turbine blade 12. As such, the laser measurement system 18 may receive the reflection(s) of the emitted laser beam(s) 22 as return signal(s). Based on the time of flight and orientation (e.g., angle(s)) of the emitted laser beam(s) 22, the laser measurement system 18 can determine the geometric parameter(s) of the wind turbine blade 12.

Additionally, the laser measurement system 18 includes one or more targets 102 (typically referred to as “drift nests” in the industry). In general, the target(s) 102 is embedded into the support surface 14 at one or more locations around the wind turbine blade 12 or other component being measured. In the illustrated embodiment, the laser measurement system 18 includes six targets 102. However, in alternative embodiments, the laser measurement system 18 may include any other suitable number of targets 102, such as more or fewer than six targets 102. As will be described below, the target(s) 102 is used to ensure that the emitter 20 did not move during scanning, thereby ensuring the accuracy of geometric measurement(s).

The configuration of the system 10 described above and shown in FIG. 1 is provided only to place the present subject matter in an exemplary field of use. Thus, the present subject matter may be readily adaptable to any manner of system for measuring component geometry.

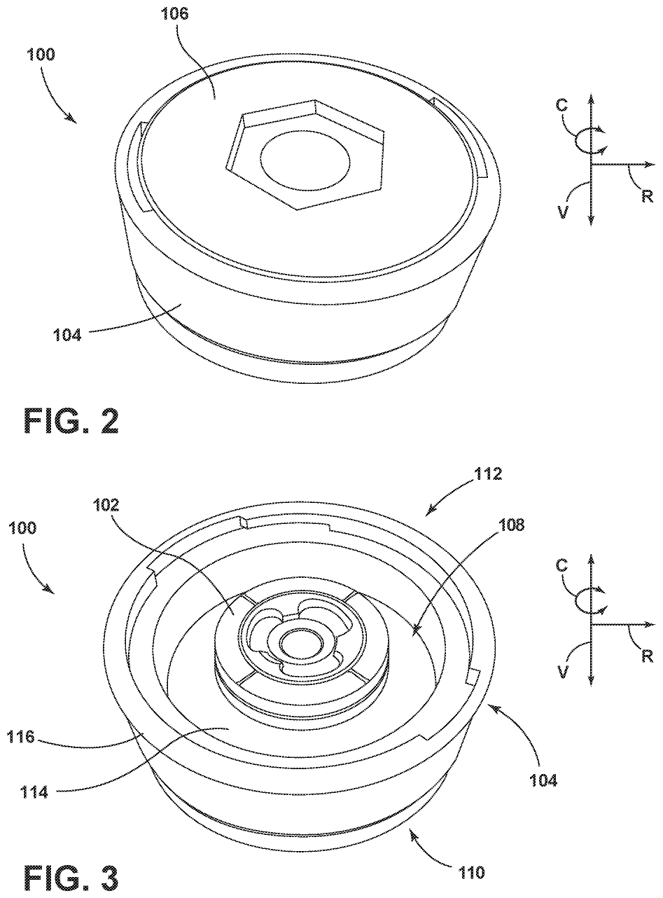

FIG. 2 is a perspective view of one embodiment of a protective assembly 100 for a target or drift nest 102 in accordance with aspects of the present subject matter. In general, the protective assembly 100 will be described herein with reference to the system 10 described above with reference to FIG. 1. However, the disclosed protective assembly 100 may generally be utilized within systems for measuring component geometry having any other suitable configuration.

As shown in FIG. 2, the protective assembly 100 includes a housing 104 and a cover 106 removably coupled to the housing 104. As will be described below, the housing 104 and the cover 106 define a chamber 108 (FIG. 3) in which the target 102 positioned. In this respect, when the cover 106 is removed from the housing 104, a reflector (not shown) received by the target 102 may be used to reflect emitted laser beams, such as before and/or after measurement of the component geometry with the laser measurement system 18. Conversely, when the cover 106 is coupled to the housing 104, the cover 106 protects the target 102 from chemicals, dust, forklifts, and/or the like.

In several embodiments, the protective assembly 100 defines a cylindrical shape. In such embodiments, the protective assembly 100 defines a vertical direction V generally extending parallel to its central axis, a radial direction R extending radially outward from the central axis, and a circumferential direction C extending circumferentially around the central axis. However, in alternative embodiments, the protective assembly 100 may define any other suitable shape.

FIG. 3 is another perspective view of the protective assembly 100 shown in FIG. 2, with the cover 106 removed to illustrate the chamber 108. As shown, the protective assembly 100 extends along the vertical direction V from a bottom end 110 to a top end 112. In this respect, the housing 104 may include a bottom wall 114 positioned at the bottom end 110 and a side wall 116 extending perpendicularly outward from the bottom wall 114 along the vertical direction V toward the top end 112. As such, the bottom wall 114 and the side wall 116 collectively define the chamber 108 within the housing 104. As mentioned above, the target 102 is positioned within the chamber 108 to selectively protect the target 102 from the environment outside of the chamber 108. Thus, as shown, the side wall 116 extends around the target 102 in the circumferential direction C.

The target 102, which is typically referred to as a “drift nest” in the industry, may have any suitable configuration for receiving a reflector that reflects a laser beam in a manner that can be used to ensure the accuracy of or otherwise validate the geometric measurements of the component (e.g., the wind turbine blade). For example, in the illustrated embodiment, the target 102 is configured as a magnetic or metallic disk to which the reflector can magnetically couple.

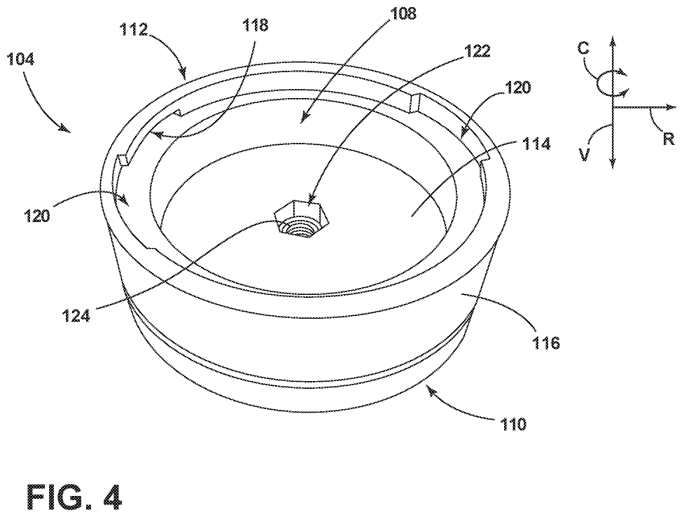

FIG. 4 is a perspective view of one embodiment of the housing 104, with the target 102 removed. In general, the housing 104 includes features that allow for the cover 106 to be removably coupled to the housing 104. Specifically, in several embodiments, the side wall 116 of the housing 104 defines one or more grooves 118, with each groove 118 configured to receive a complementary projection on the cover 106. As shown, the groove(s) 118 extend outward from the chamber 108 into the side wall 116 in the radial direction R. Moreover, each groove 118 extend partially around the circumference of the side wall 116 in the circumferential direction C. Furthermore, the side wall 116 defines one or more openings 120 extending from the top end 112 of the housing 104 to the corresponding groove 118 in the vertical direction V. In this respect, the opening(s) 120 allows the projection(s) of the cover 106 to move into and out of the groove(s) 118, thereby permitting the cover 106 to be coupled to and removed from the housing 104. In the illustrated embodiment, the housing 104 includes two sets of grooves 118 and openings 120, with the sets being spaced apart from each other by 180 degrees. In other embodiments, the housing 104 may define any other suitable number of grooves/openings 118/120. However, in alternative embodiments, the housing 104 may include any other features and/or have any other configuration that allow for the cover 106 to be removably coupled to the housing 104.

In some embodiments, the bottom wall 114 of the housing 104 may define a cavity 122 for coupling the target 102 to the bottom wall 114. For example, in the illustrated embodiment, a threaded sleeve 124 may be installed in the cavity 122, thereby allowing the target 102 to be threadingly coupled to the housing 104. Alternatively, the target 102 may be adhesively coupled to the bottom wall 114 of the housing 104.

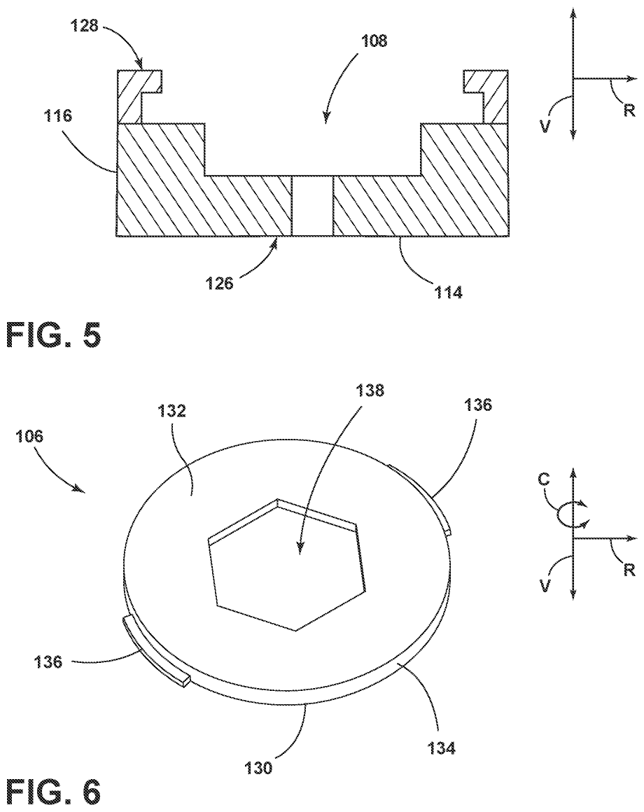

Furthermore, the housing 104 may be formed in any suitable manner. For example, in the embodiment shown in FIG. 4, the housing 104 is integrally formed as a single component, such as via a suitable additive manufacturing process (e.g., 3D printing). Conversely, in the embodiment shown in FIG. 5, the housing 104 is formed from formed from a first piece 126 and separate, second piece 128 that are coupled together. Such a two-piece construction allows the housing 104 with the groove(s) 118 and the opening(s) 120 to be formed via casting/molding.

FIG. 6 is a perspective view of one embodiment of the cover 106. As shown, the cover 106 is generally cylindrical. In this respect, the cover extends in the vertical direction V from a bottom surface 130 to a top surface 132. Additionally, the cover 106 includes an outer surface 134 extending around the outer radial periphery of the cover 106 in the circumferential direction C. However, in alternative embodiments, the cover 106 may have any other suitable shape.

As shown, the cover 106 includes features that allow for the cover 106 to be removably coupled to the housing 104. Specifically, in several embodiments, the cover includes one or more projections 136 extending outward from the outer surface 134 of the cover 106. As such, the projection(s) 136 is configured to be received by the opening(s) 120 and the groove(s) 118, thereby allowing the cover 106 to be removably coupled to the housing 104. For example, the projections(s) 136 may move into and out of the groove(s) 118 via the opening(s) 120. In this respect, when the cover 106 is rotated relative to the housing 104, the projection(s) 136 moves within the groove(s) 120 between a first circumferential position aligned with the opening(s) 120 and a second circumferential position offset from the opening(s) 120. Thus, the projection(s) 136 may have a tab-like shape. In the illustrated embodiment, the cover 106 includes two projections 136, with the projections 136 being spaced apart from each by 180 degrees. In other embodiments, the cover 106 may have any other suitable number of projections 136. However, in alternative embodiments, the cover 106 may include any other features and/or have any other configuration that allows for the cover 106 to be removably coupled to the housing 104.

Moreover, in some embodiments, the cover 106 defines a cavity 138. Specifically, in such embodiments, the cavity 138 extends from the top surface 132 of the cover 106 downward in the vertical direction V toward the bottom surface 130 of the cover 106. In this respect, the cavity 138 may be configured to receive a tool (e.g., the tool 200 described below), thereby allowing a user to couple and remove the cover 106 from the housing 104. For example, in the illustrated embodiment, the cavity 138 defines a hexagonal shape. However, in other embodiments, the cavity 138 may have any other suitable shape and/or configuration. In addition, in further embodiments, the cover 106 may include a projection (not shown) in lieu of the cavity 138 that allows for engagement by a tool.

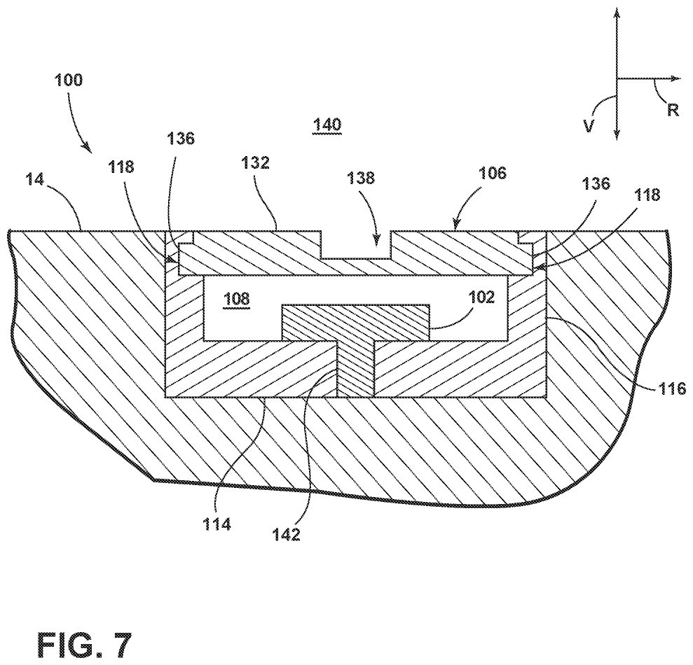

FIG. 7 is a cross-sectional view of the protective assembly 100. As shown, the protective assembly 100 is embedded or otherwise positioned within the support surface 14. Specifically, in several embodiments, the housing 104 is embedded within the support surface 14 such that, when the cover 106 is coupled to the housing 104, the top surface 132 of the cover 106 is aligned with the support surface 14 in the vertical direction V. As such, the target 102 may be positioned below the support surface 14. In this respect, when the cover 106 is coupled to the housing 104, access to the chamber 108 within the protective assembly 100 is occluded to protect the target 102 from an environment 140 outside of the chamber 108. This, in turn, protects the target 102 from dust, chemicals, forklifts, and/or the like present within the environment 140 when not in use. Conversely, when the cover 106 is removed from the housing 104, access to the chamber 108 within the protective assembly 100 is provided to allow a reflector (not shown) coupled to the target 102 to reflect a laser beam(s). Moreover, by embedding the protective assembly 100 within the support surface 14, the target 102 can be permanently installed, while being protected from the environment 140 when not in use. Thus, the protective assembly 100 eliminates the need to adhesively couple targets to the wind turbine blade 12.

The support surface 14 may correspond to any surface configured to support a component (and an associated jig) during measurement. For example, in several embodiments, the support surface 14 may correspond to a building or shop floor on which the component is supported (e.g., the wind turbine blade 12 and the jig 16).

Additionally, as shown, in some embodiments, the target 102 may include a shaft 142 extending outwardly therefrom. In one embodiment, the shaft 142 may allow the target 102 to be threadingly coupled to the housing 104. However, in another embodiment, the shaft 142 may allow the target 102 to be adhesively coupled to the housing 104.

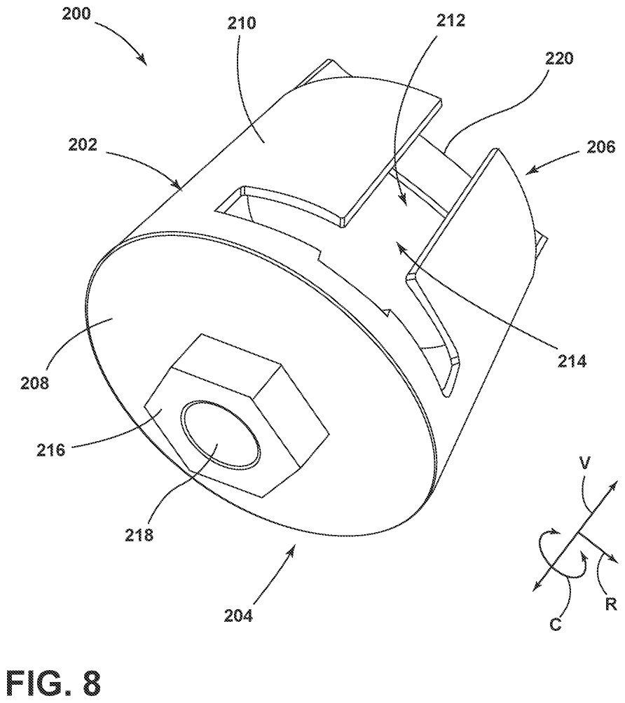

FIG. 8 is a perspective view of one embodiment of a tool 200 for installing and removing the cover 106 from the housing 104. As shown, the tool 200 includes a body 202 extending between a first end 204 and an opposed second end 206. In the illustrated embodiment, the body 202 defines a cylindrical shape. In such embodiments, the tool 200 defines a vertical direction V generally extending parallel to a central axis extending between the first end 204 and the second end 206, a radial direction R extending radially outward from the central axis, and a circumferential direction C extending circumferentially around the central axis. However, in alternative embodiments, the protective assembly 100 may define any other suitable shape.

As shown, the body 202 includes a bottom wall 208 and a side wall 210. More specifically, the bottom wall 208 is positioned at the first end 204 of the body 202. Furthermore, the side wall 210 extends perpendicularly outward from the bottom wall 208 along the vertical direction V toward the second end 206. As such, the bottom wall 208 and the side wall 210 collectively define a chamber 212 within the body 202. As will be described below, the cover 106 of the protective assembly 100 may, when removed from the housing 104, be positioned within the chamber 212 of the tool body 202. Additionally, the side wall 210 may further define an opening 214 extending therethrough to provide access to the chamber 212 through the side wall 210. In this respect, the opening 214 may allow the user to manipulate the cover 106 when positioned within the chamber 212.

Moreover, the tool 200 may include a projection 216 extending outward from the first end 204 of the body 202. In this respect, the projection 216 is configured to engage the cavity 138 defined by the cover 106. As such, when the projection 216 is positioned within the cavity 138, the tool 200 may be rotated in the circumferential direction C to rotate the cover 106 relative to the housing 104 (such that the projections 136 are rotated within the grooves 118), thereby installing or removing the cover 106. Thus, the projection 216 generally defines a complementary shape to the cavity 138. For example, the projection 216 and the cavity 138 may both have hexagonal shapes. However, in alternative embodiments, the projection 216 and the cavity 138 may have any other suitable shapes.

In one embodiment, the projection 216 includes a magnetic portion 218. In this respect, the magnetic portion 218 allows the projection to be temporarily coupled to the cover 106, thereby facilitating easy installation and removal of the cover 106.

Additionally, the tool 200 may include a handle 220 coupled to the second end 206 of the body 202. As such, the handle 220 allows the user to grasp and manipulate the tool 200, such as when installing or removing the cover 106.

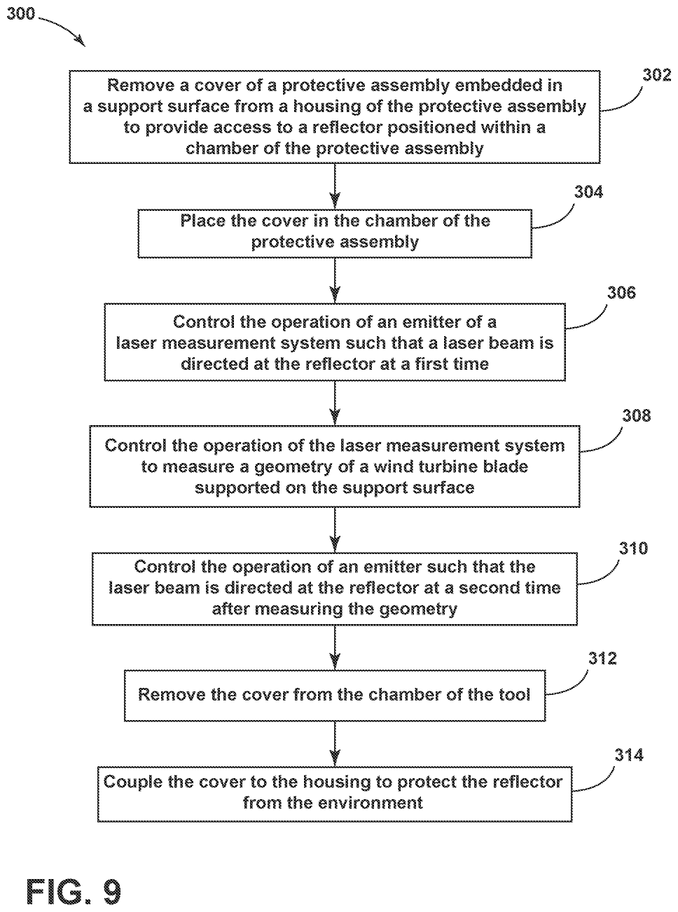

FIG. 9 is a flow diagram of one embodiment of a method 300 for method for measuring wind turbine blade geometry. In general, the method 300 will be described herein with reference to the system 10, the protective assembly 100, and the tool 200 described above with reference to FIGS. 1-8. However, the disclosed method 300 may generally be implemented with any suitable system, protective assembly, and/or tool. In addition, although FIG. 9 depicts steps performed in a particular order for purposes of illustration and discussion, the methods discussed herein are not limited to any particular order or arrangement. As such, various steps of the methods disclosed herein can be omitted, rearranged, combined, and/or adapted in various ways without deviating from the scope of the present disclosure.

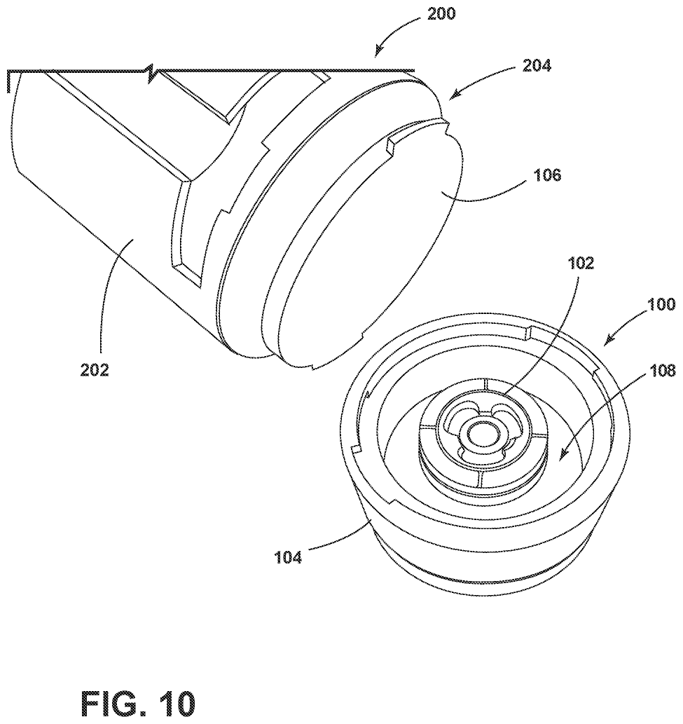

As shown, at (302), the method 300 includes removing a cover of a protective assembly embedded in a support surface from a housing of the protective assembly to provide access to a target positioned within a chamber of the protective assembly. For example, in several embodiments, the cover 106 of the protective assembly 100 embedded within the support surface 14 may be removed from the housing 104 of the protective assembly 100 to provide access to the target 102 positioned within the cavity 138 of the protective assembly 100. In some embodiments, the cover 106 may be rotated relative to the housing 104 to remove the cover 106. In some embodiments, the tool 200 may be used to remove the cover 106 from the housing 104. FIG. 10 illustrates using the tool 200 to remove the cover 106 from the housing 104. Alternatively, any other suitable tool (e.g., an Allen wrench) may be used.

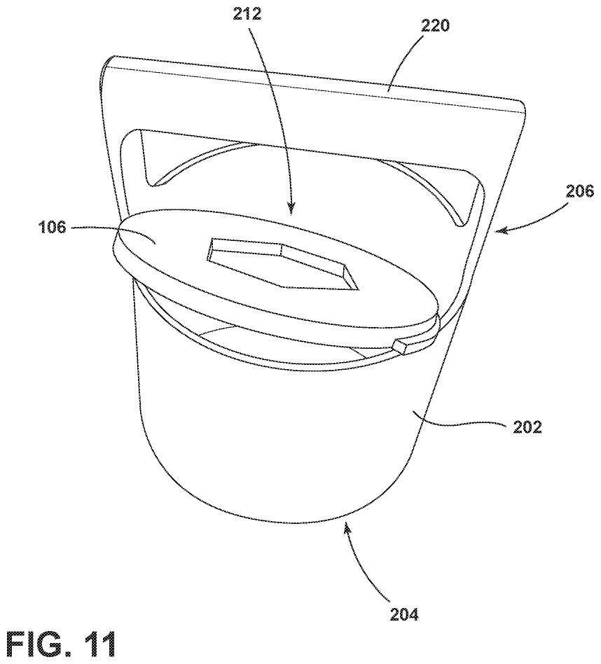

Referring again to FIG. 9, at (304), the method 300 includes placing the cover in the chamber within the body after removing the cover. For example, in several embodiments, as shown in FIG. 11, the removed cover 106 is placed in the chamber 212 of the tool 200. This may prevent losing the cover 106 when the cover 106 is removed.

Referring again to FIG. 9, at (306), the method 300 includes controlling an operation of an emitter of a laser measurement system such that a laser beam is directed at the target at a first time. For example, in several embodiments, the operation of the emitter 20 of the laser measurement system 18 is controlled such that the laser beam(s) 22 is directed at a reflector (not shown) received by the target 102 (e.g., as shown in FIG. 1) at a first time (e.g., before measurement of the geometry).

Furthermore, at (308), the method 300 includes controlling the operation of the laser measurement system to measure a geometry of a wind turbine blade supported on the support surface. For example, in several embodiments, the operation of the laser measurement system 18 to measure the geometry of the wind turbine blade 12 supported on the support surface 14 via the jig 16.

Additionally, at (310), the method 300 includes controlling the operation of the emitter such that the laser beam is directed at the target at a second time after measuring the geometry. For example, in several embodiments, the operation of the emitter 20 of the laser measurement system 18 is controlled such that the laser beam(s) 22 is directed at the reflector received by the reflector 102 (e.g., as shown in FIG. 1) at a second time (e.g., after measurement of the geometry).

Moreover, at (312), after controlling the operation of the emitter such that the laser beam is directed at the target the second time, the method 300 includes removing the cover from the chamber within the body. For example, in several embodiments, the cover 106 is removed from the chamber 212 of the tool 200.

In addition, at (314), the method 300 includes coupling the cover to the housing to protect the target from an environment outside of the chamber. For example, in several embodiments, the cover 106 is coupled to the housing 104 to protect the target 102 from the environment 140 outside of the chamber 108 of the protective assembly 100. In some embodiments, the cover 106 may be rotated relative to the housing 104 to couple the cover 106 to the housing 104. In some embodiments, the tool 200 may be used to couple the cover 106 to the housing 104. Alternatively, any other suitable tool (e.g., an Allen wrench) may be used.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A protective assembly for a laser measurement system configured to measure geometry of a component, the protective assembly comprising:
a housing configured to be embedded in a support surface on which the component is supported, the housing including a bottom wall and a side wall coupled to the bottom wall such that the housing defines a chamber therein;
a target positioned within the chamber, the target configured receive a reflector that reflects a laser beam emitted by an emitter of the laser measurement system; and
a cover configured to be removably coupled to the housing such that, when the cover is coupled to the housing, access to the chamber is occluded to protect the target from an environment outside of the chamber.

2. The protective assembly of claim 1, wherein the cover comprises a projection extending outward from an outer surface of the cover and the side wall of the housing defines a groove configured to receive the projection such that, when the cover is rotated relative to the housing, the projection moves within the groove.

3. The protective assembly of claim 2, wherein the side wall of the housing further defines an opening extending from a top end of the housing to the groove such that the opening allows the projection of the cover to move into and out of the groove.

4. The protective assembly of claim 1, wherein the cover defines a cavity configured to be engaged by a tool for removing the cover from the housing.

5. The protective assembly of claim 4, wherein the tool comprises:
a body having a first end and a second end opposed to the first end;
a projection extending outward from the first end of the body, the projection configured to engage a cavity defined by the cover; and
a handle coupled to the second end of the body.

6. The protective assembly of claim 5, wherein the body of the tool includes a side wall at least partially defining a chamber within the body, the chamber within the body configured to receive the cover when the cover is removed from the housing.

7. The protective assembly of claim 6, wherein the side wall further defines an opening extending therethrough to provide access to the chamber within the body through the side wall.

8. The protective assembly of claim 5, wherein the projection comprises a magnetic portion.

9. The protective assembly of claim 1, wherein the target is threadingly coupled to the bottom wall of the housing.

10. The protective assembly of claim 1, wherein the target is adhesively coupled to the bottom wall of the housing.

11. The protective assembly of claim 1, wherein the housing integrally formed.

12. The protective assembly of claim 1, wherein the housing is formed from a first piece and separate, second piece that are coupled together.

13. The protective assembly of claim 1, wherein the component comprises a wind turbine blade.

14. A system for measuring wind turbine blade geometry, the system comprising:
a laser measurement system comprising:
an emitter configured to emit a laser beam for use in measuring geometry of a wind turbine blade; and
a target configured to receive a reflector that reflects the laser beam emitted by the emitter;
a support surface on which the laser measurement system and the wind turbine blade are supported; and
a protective assembly comprising:
a housing embedded in the support surface, the housing including a bottom wall and a side wall coupled to the bottom wall such that the housing defines a chamber therein, the target being positioned within the chamber; and
a cover configured to be removably coupled to the housing such that, when the cover is coupled to the housing, access to the chamber is occluded to protect the target from an environment outside of the chamber.

15. The system of claim 14, wherein the support surface is a building floor.

16. The system of claim 14, wherein, when the cover is coupled to the housing, a top surface of the cover is aligned with the support surface in a vertical direction.

17. A method for measuring wind turbine blade geometry, the method comprising:
removing a cover of a protective assembly embedded in a support surface from a housing of the protective assembly to provide access to a target positioned within a chamber of the protective assembly;
controlling an operation of an emitter of a laser measurement system such that a laser beam is directed at the target at a first time;
controlling the operation of the laser measurement system to measure a geometry of a wind turbine blade supported on the support surface;
controlling the operation of the emitter such that the laser beam is directed at the target at a second time after measuring the geometry; and
coupling the cover to the housing to protect the target from an environment outside of the chamber.

18. The method of claim 17, wherein removing the cover comprises removing the cover from the housing with a tool including a body defining a chamber configured to receive the cover.

19. The method of claim 18, further comprising:
placing the cover in the chamber within the body after removing the cover.

20. The method of claim 19, further comprising:
removing the cover from the chamber after controlling the operation of the emitter such that the laser beam is directed at the target the second time.
